(19) United States
(12) Patent Application Publication
(10) Pub. No.: US 2009/0115576 A1
(43) Pub. Date: May 7, 2009

(54) Efficient Variable Format Data Encodation in RFID Tags and Other Media

(75) Inventor: Frederick Schuessler, Baiting Hollow, NY (US)

Correspondence Address: MOTOROLA, INC., 1303 EAST ALGONQUIN ROAD, IL01/3RD, SCHAUMBURG, IL, 60196, US

(73) Assignee: Symbol Technologies, Inc., Holtsville, NY (US)

(21) Appl. No.: 12/165,581

(22) Filed: Jun. 30, 2008

Related U.S. Application Data
(60) Provisional application No. 60/985,182, filed on Nov. 2, 2007.
(60) Provisional application No. 60/985,594, filed on Nov. 5, 2007.

(51) Int. Cl. H04Q 5/22; G06F 7/00

(52) U.S. Cl. 340/10.1; 707/100; 707/E17.044

(57) ABSTRACT

An embodiment includes a data structure embodied in a tangible computer readable medium comprising a data section encoding at least one data item and an identification map having a plurality of bits, each bit corresponding to an entry in an external table. Another embodiment includes a system of data structures embodied in a tangible computer readable medium comprising at least one data structure, each data structure encoding at least one data item and an identification map having a plurality of fields indicating the presence of a data item. Another embodiment includes a system of structures comprising a data structure including a previously encoded data item, a deletion list, and an addition list.

### CROSS REFERENCE TO RELATED APPLICATIONS

This application claims benefit of U.S. Provisional Application No. 60/985,182, entitled “Systems And Methods For Efficient Variable Format Data Encodation In RFID Tags And Other Media,” filed Nov. 2, 2007; and U.S. Provisional Application No. 60/985,594, entitled “Systems And Methods For Efficient Variable Format Data Encodation In RFID Tags And Other Media,” filed Nov. 5, 2007, both of which are incorporated by reference herein in its entirety.

### FIELD OF THE INVENTION

The invention relates generally to encoding and decoding of data, and in particular, to encoding and decoding of variable format user data in RFID tags and optical media.

### BACKGROUND OF THE INVENTION

### 1.0 Radio Frequency Identification (RFID) Tags

Radio frequency identification (RFID) tags are electronic devices that may be affixed to items whose presence is to be detected and/or monitored. A variety of tag classes have been defined by national and international standards bodies (e.g., EPCGlobal and ISO). The tag classes include Class 0, Class 1, and Class 1 Generation 2 (“Gen 2”). The presence of an RFID tag, and therefore the presence of the item to which the tag is affixed, may be checked and monitored wirelessly by devices known as “readers.” Readers typically have one or more antennas transmitting radio frequency signals to which tags respond. Because the reader “interrogates” RFID tags, and receives signals back from the tags in response to the interrogation, the reader is sometimes termed as “reader interrogator” or simply “interrogator.”

With the maturation of RFID technology, efficient communication between tags and interrogators has become a key enabler in supply chain management, especially in manufacturing, shipping, and retail industries, as well as in building security installations, healthcare facilities, libraries, airports, warehouses etc.

In addition, tags include limited amounts of memory for encoding user data. Existing standard data formats (e.g., as specified by ISO/IEC 15961 and 15962) do not offer good compaction efficiency, nor do they offer fast random access to a desired data element. In addition, Gen 2 standards limit the data systems which can be used to label data items. This limits the ability of users of Gen 2 tags to encode data items. Some users may desire to use GSI Application Identifiers (AIs), whereas others may want to use Data Identifiers (DIs), and others may want to intermix the two. Furthermore, the Gen 2 air interface protocol does not provide a good mechanism for accessing a variable amount of memory, without requiring multiple operations of the same tag. In current Gen 2 implementations, the only options are (1) read the entire memory bank, which may entail reading a very large number of useless ‘0’ bits thus slowing down the process for reading a population of tags, or (2) read a selected number of memory words. The problem with alternative (2) is that if too many words are requested, the tag returns an error code with no indication of how many words were actually available.

### 2.0 Optical Media

Optical media such as bar codes are machine readable representations of information, often dark ink on a light background that creates high and low reflectance which can be converted to a digital format. Barcodes may represent or encode data by the widths and spacings of printed parallel lines, patterns of dots, concentric circles, and text codes hidden within images. Barcodes are often read by optical scanners called barcode readers or scanned from an image by special software.

Barcodes are widely used to implement Auto ID Data Capture (AIDC) systems that improve the speed and accuracy of computer data entry. Barcodes are typically extremely accurate and inexpensive. However, the amount and type of data that can be encoded in a bar code is limited.

The drive to encode more information in combination with the space requirements of simple barcodes led to the development advanced bar codes such as stacked barcodes and 2D barcodes. For example, matrix codes, a type of 2D barcode, do not consist of bars but rather a grid of square cells. Stacked barcodes are a compromise between true 2D barcodes and linear codes (also known as 1D barcodes), and are formed by taking a traditional linear symbology and placing it in an envelope that allows multiple rows.

### 3.0 Encoding Data Items Into Data Carriers

Most schemes for open-system encoding of data items into data carriers fall into two broad categories, fixed-format and variable-format.

Fixed-Format, in which case (for open-systems use) an industry must agree to which data items shall be encoded, in which order, and at which maximum size (so the same data item always appears in the same relative location), and

Variable-Format, in which case each data item is prefaced by a data identifier (unique within the governing data system), and the encoding system may choose to encode onto the data carrier any arbitrary subset of the defined data system data elements, and may also encode variable-length data items in the minimum possible amount of space on the data carrier.

These schemes fail to meet one or more of the following important goals: (1) Minimizing the amount of memory (e.g. RFID tag memory, barcode real estate, etc.) necessary to encode end-user data; (2) Minimizing the total amount of data transmissions required to convey a desired set of data elements to or from a population media (e.g., RFID tags, barcodes, etc.); and (3) Taking full advantage of the read/write capability (e.g., of RFID Tags), while minimizing the number of bits that need to be re-written in order to add, delete, or modify tag data. In the case of RFID, it takes much more time to Write than it does to Read.

Fixed-Format schemes fall short on the first goal, because they require all users to encode all defined data items at agreed-upon fixed lengths-otherwise, the data elements cannot be encoded at predefined memory locations. They also fall short on the second goal. By their nature, Fixed-Format schemes do not support either adding or deleting data items. They may support re-writing existing data items, however, since existing data items may be written at a fixed size.

Variable-Format schemes also fall short on the second goal. For example, in order to acquire selected elements from a population of tags, the RFID interrogator must bring over the air at least some non-essential data from every tag in the population to determine whether a given tag contains the desired data. Variable-format schemes also typically fall short on the third goal. They require moving (and thus rewriting) all of the data subsequent to the edit point to delete or modify an existing data item.

Thus, what is needed is a variable-format data encodation scheme, wherein the listing of the data identifiers present on the data carrier is compactly represented. What is also needed is a variable-format data encodation scheme, wherein the listing of the data identifiers present on the data carrier is effectively compacted when encoding a substantial percentage of the full set in a profile.

What is also needed is a variable-format data encodation scheme, wherein a single Select operation, or a small number of Select operations, can select or unselect, from a population of media instances (e.g., RFID tags), those instances that do or do not contain one or more specified data identifiers of interest.

What is also needed is a variable-format data encodation scheme, wherein Add, Delete, and Modify editing operations can be performed on encoded data, while minimizing the need to rewrite the data that is not the target of the editing operation.

What is also needed is a variable-format data encodation scheme including a directory or mini-directory, wherein Add, Delete, and Modify editing operations can be performed on encoded data, without invalidating the directory or mini-directory information.

What is also needed is a defined data carrier directory method, wherein the directory can be encoded in the same memory region as its associated data, insofar as the directory maintains a fixed size as new data items are added. This data carrier directory method could further be applicable to Fixed-Format schemes.

### BRIEF SUMMARY OF THE INVENTION

An embodiment includes a data structure embodied in a tangible computer readable medium comprising a data section encoding at least one data item and an identification map having a plurality of bits, each bit corresponding to an entry in an external table. Another embodiment includes a system of data structures embodied in a tangible computer readable medium comprising at least one data structure, each data structure encoding at least one data item and an identification map having a plurality of fields indicating the presence of a data item. Another embodiment includes a system of structures comprising a data structure including a previously encoded data item, a deletion list, and an addition list.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1A shows an example environment where RFID readers communicate with an exemplary population of RFID tags.

FIG. 1B shows an example environment where barcode readers read an exemplary population of barcodes.

FIG. 2A shows a block diagram of receiver and transmitter portions of an RFID reader.

FIG. 2B shows a block diagram of an exemplary barcode reader.

FIG. 3A shows a block diagram of an exemplary radio frequency identification (RFID) tag.

FIG. 3B shows exemplary barcodes.

FIG. 4 depicts an exemplary logical memory map for a Gen-2 tag memory.

FIG. 5 depicts an example high-level format for a user memory bank of an RFID tag, according to embodiments of the invention.

FIG. 6 depicts an exemplary data structure (e.g. a Packed Object) having an exemplary ID Map and an exemplary addendum according to embodiments of the present invention.

FIG. 7 depicts an example table of defined ID Value sizes according to embodiments of the present invention.

FIG. 8A-8B shows flowcharts illustrating exemplary methods for editing a data structure according to embodiments of the present invention.

FIG. 9 shows a flowchart illustrating an exemplary method for reading at least one desired data item according to embodiments of the present invention.

The present invention will now be described with reference to the accompanying drawings. In the drawings, like reference numbers may indicate identical or similar elements. Additionally, the left-most digit(s) of a reference number may identify the drawing in which the reference number first appears.

### DETAILED DESCRIPTION OF THE INVENTION

### 1.0 Exemplary Operating Environment

The methods and systems described herein are applicable to multiple media, including optical (e.g., barcode) and RFID implementations. For brevity, the examples herein concentrate on RFID applications.

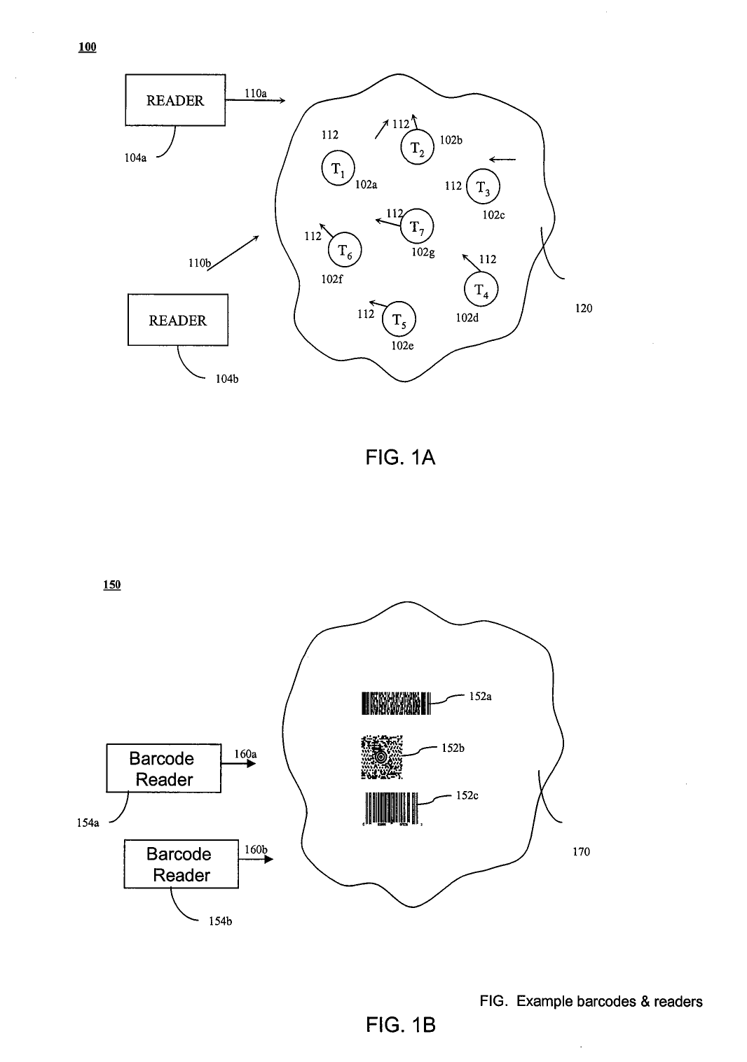

Before describing embodiments of the present invention in detail, it is helpful to describe example barcode and RFID communications environments in which the invention may be implemented. FIG. 1A illustrates an environment 100 where RFID tag readers 104 (also referred to as “interrogators”) communicate with an exemplary population 120 of RFID tags 102. As shown in FIG. 1A, the population 120 of tags includes seven tags 102a-102g. A population 120 may include any number of tags 102.

Environment 100 includes any number of one or more readers 104. For example, environment 100 includes a first reader 104a and a second reader 104b. Readers 104a and/or 104b may be requested by an external application to address the population of tags 120. Alternatively, reader 104a and/or reader 104b may have internal logic that initiates communication, or may have a trigger mechanism that an operator of a reader 104 uses to initiate communication. Readers 104a and 104b may also communicate with each other in a reader network.

As shown in FIG. 1A, reader 104a transmits an interrogation signal 110a having a carrier frequency to the population of tags 120. Reader 104b transmits an interrogation signal 110b having a carrier frequency to the population of tags 120. Readers 104a and 104b typically operate in one or more of the frequency bands allotted for this type of RF communication. For example, frequency bands of 902-928 MHz and 2400-2483.5 MHz have been defined for certain RFID applications by the Federal Communication Commission (FCC).

Various types of tags 102 may be present in tag population 120 that transmit one or more response signals 112 to an interrogating reader 104, including by alternatively reflecting and absorbing portions of signal 110 according to a time-based pattern or frequency. This technique for alternatively absorbing and reflecting signal 110 is referred to herein as backscatter modulation. Readers 104a and 104b receive and obtain data from response signals 112, such as an identification number of the responding tag 102. In the embodiments described herein, a reader may be capable of communicating with tags 102 according to any suitable communication protocol, including Class 0, Class 1, EPC Gen 2, other binary traversal protocols and slotted aloha protocols, any other protocols mentioned elsewhere herein, and future communication protocols. Additionally, tag population 120 may include one or more tags having the Packed Object format described herein and/or one or more tags not using the Packed Object format (e.g., standard ISO tags).

FIG. 1B illustrates an environment 150 where 1 or more barcode readers 154 read a population of barcodes 170. An exemplary barcode reader uses internal or external light 160, which reflects off of the barcode, and scans the barcode. Barcode readers are well known in the art. Barcode reader 154 is configured to read optically readable symbols. In embodiments, barcode reader 154 may include any type of barcode scanner front end, including a light source (e.g., photodiode), a laser scanner, a charge coupled device (CCD) reader, and/or a 2D symbol imaging scanner (e.g., a video camera). Barcode reader 154 may further include processing logic for decoding received symbol information.

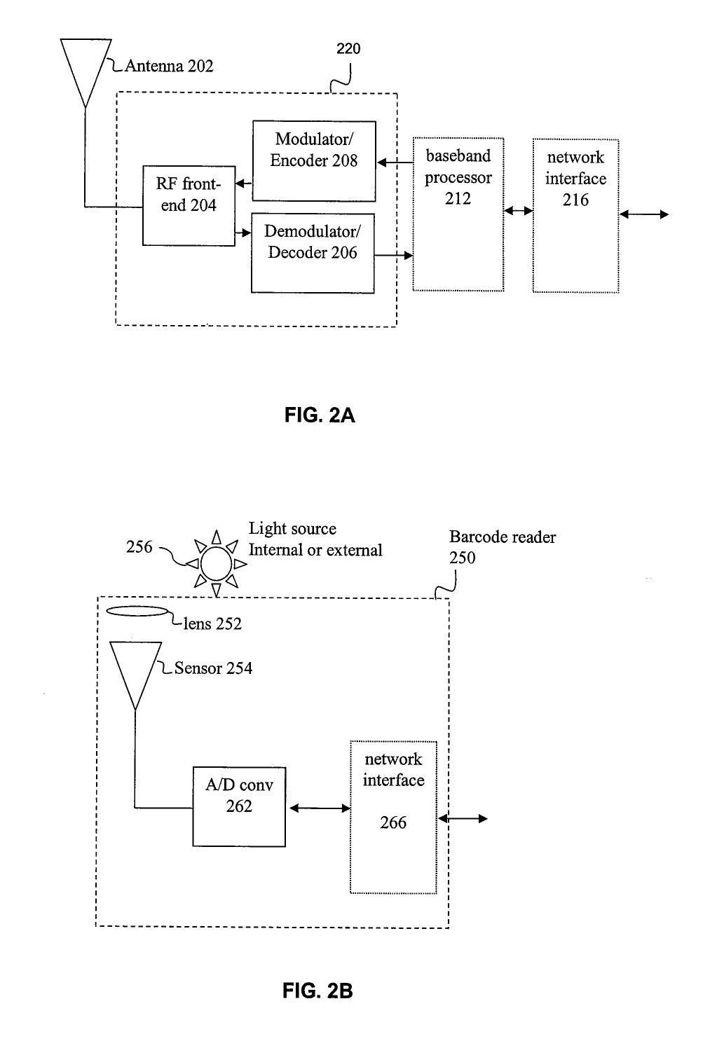

FIG. 2A shows a block diagram of an example RFID reader 104. Reader 104 includes one or more antennas 202, a receiver and transmitter portion 220 (also referred to as transceiver 220), a baseband processor 212, and a network interface 216. These components of reader 104 may include software, hardware, and/or firmware, or any combination thereof, for performing their functions.

Baseband processor 212 and network interface 216 are optionally present in reader 104. Baseband processor 212 may be present in reader 104, or may be located remote from reader 104. For example, in an embodiment, network interface 216 may be present in reader 104, to communicate between transceiver portion 220 and a remote server that includes baseband processor 212. When baseband processor 212 is present in reader 104, network interface 216 may be optionally present to communicate between baseband processor 212 and a remote server. In another embodiment, network interface 216 is not present in reader 104.

In an embodiment, reader 104 includes network interface 216 to interface reader 104 with a communications network 218. As shown in FIG. 2A, baseband processor 212 and network interface 216 communicate with each other via a communication link 222. Network interface 216 is used to provide an interrogation request to transceiver portion 220 (optionally through baseband processor 212), which may be received from a remote server coupled to communications network 218. Baseband processor 212 optionally processes the data of interrogation request 210 prior to being sent to transceiver portion 220. Transceiver 220 transmits the interrogation request via antenna 202.

Reader 104 has at least one antenna 202 for communicating with tags 102 and/or other readers 104. Antenna(s) 202 may be any type of reader antenna known to persons skilled in the relevant art(s), including a vertical, dipole, loop, Yagi-Uda, slot, or patch antenna type.

Transceiver 220 receives a tag response via antenna 202. Transceiver 220 outputs a decoded data signal 214 generated from the tag response. Network interface 216 is used to transmit decoded data signal 214 received from transceiver portion 220 (optionally through baseband processor 212) to a remote server coupled to communications network 218. Baseband processor 212 optionally processes the data of decoded data signal 214 prior to being sent over communications network.

In embodiments, network interface 216 enables a wired and/or wireless connection with communications network 218. For example, network interface 216 may enable a wireless local area network (WLAN) link (including a IEEE 802.11 WLAN standard link), a BLUETOOTH link, and/or other types of wireless communication links. Communications network 218 may be a local area network (LAN), a wide area network (WAN) (e.g., the Internet), and/or a personal area network (PAN).

In embodiments, a variety of mechanisms may be used to initiate an interrogation request by reader 104. For example, an interrogation request may be initiated by a remote computer system/server that communicates with reader 104 over communications network. Alternatively, reader 104 may include a finger-trigger mechanism, a keyboard, a graphical user interface (GUI), and/or a voice activated mechanism with which a user of reader 104 may interact to initiate an interrogation by reader 104.

In the example of FIG. 2A, transceiver portion 220 includes a RF front-end 204, a demodulator/decoder 206, and a modulator/encoder 208. These components of transceiver 220 may include software, hardware, and/or firmware, or any combination thereof, for performing their functions. Example description of these components is provided as follows.

Modulator/encoder 208 receives interrogation request 210, and is coupled to an input of RF front-end 204. Modulator/encoder 208 encodes interrogation request 210 into a signal format, such as one of pulse-interval encoding (PIE), FM0, or Miller encoding formats, modulates the encoded signal, and outputs the modulated encoded interrogation signal to RF front-end 204.

RF front-end 204 may include one or more antenna matching elements, amplifiers, filters, an echo-cancellation unit, a down-converter, and/or an up-converter. RF front-end 204 receives a modulated encoded interrogation signal from modulator/encoder 208, up-converts (if necessary) the interrogation signal, and transmits the interrogation signal to antenna 202 to be radiated. Furthermore, RF front-end 204 receives a tag response signal through antenna 202 and down-converts (if necessary) the response signal to a frequency range amenable to further signal processing.

Demodulator/decoder 206 is coupled to an output of RF front-end 204, receiving a modulated tag response signal from RF front-end 204. In an EPC Gen 2 protocol environment, for example, the received modulated tag response signal may have been modulated according to amplitude shift keying (ASK) or phase shift keying (PSK) modulation techniques. Demodulator/decoder 206 demodulates the tag response signal. For example, the tag response signal may include backscattered data formatted according to FM0 or Miller encoding formats in an EPC Gen 2 embodiment. Demodulator/decoder 206 outputs decoded data signal.

The configuration of transceiver 220 shown in FIG. 2A is provided for purposes of illustration, and is not intended to be limiting. Transceiver 220 may be configured in numerous ways to modulate, transmit, receive, and demodulate RFID communication signals, as would be known to persons skilled in the relevant art(s).

Similarly, FIG. 2B shows a block diagram of an exemplary barcode reader 250. Barcode readers are well known in the art. Barcode reader 250 may be of any type. Barcode reader 250 may include an internal or external light source 256 of any type (e.g., photodiode) or may use ambient light. Barcode reader lens 252 focuses light reflected off of a barcode. Light sensor 254 of any type (e.g., a charge coupled device, video camera, etc.) detects the pattern of the barcode. A/D converter 262 converts an analog signal from sensor 254 to digital. Network interface 266 enables communications with a communications network.

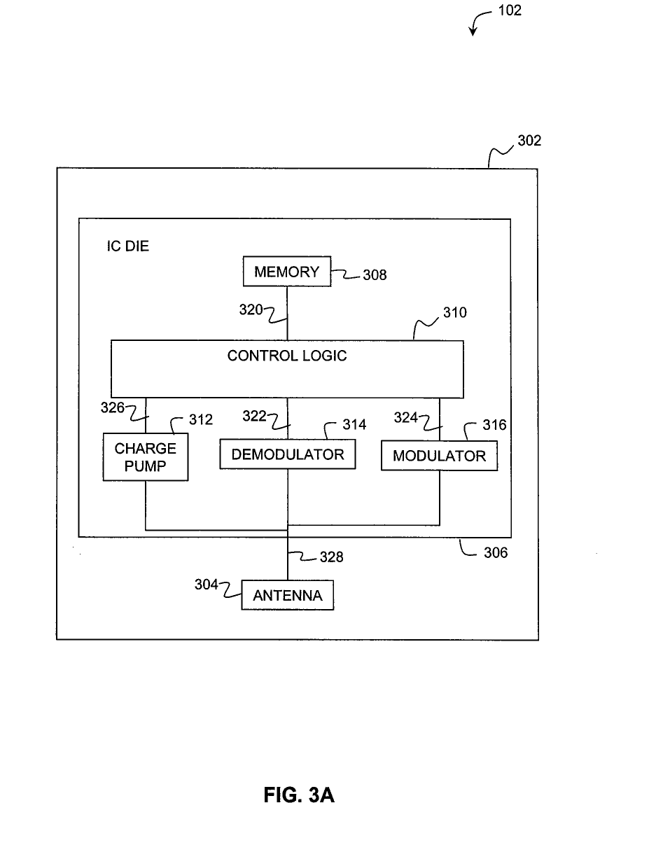

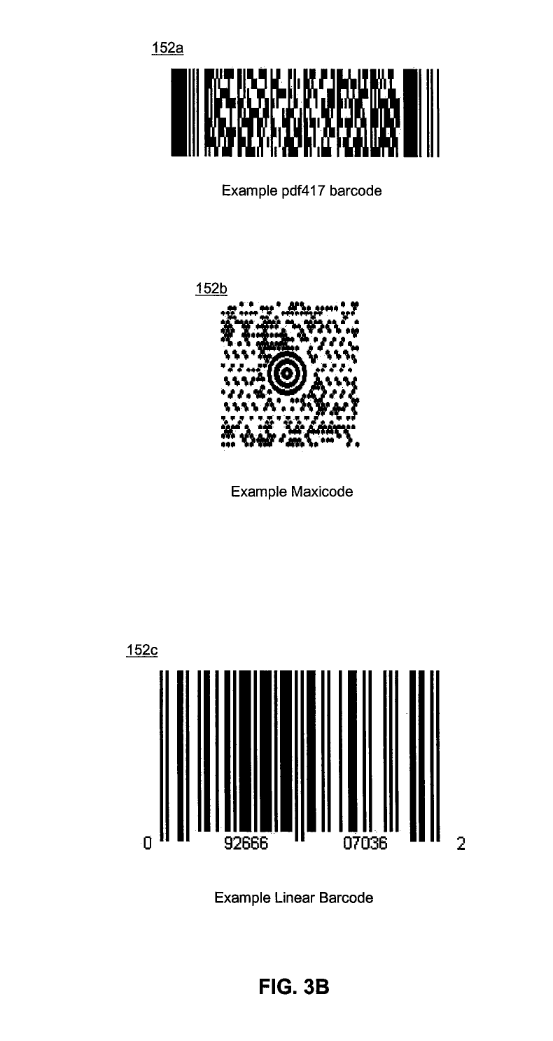

FIG. 3A shows a plan view of an example radio frequency identification (RFID) tag 102. Tag 102 includes a substrate 302, an antenna 304, and an integrated circuit (IC) 306. Antenna 304 is formed on a surface of substrate 302. Antenna 304 may include any number of one, two, or more separate antennas of any suitable antenna type, including dipole, loop, slot, or patch antenna type. IC 306 includes one or more integrated circuit chips/dies, and can include other electronic circuitry. IC 306 is attached to substrate 302, and is coupled to antenna 304. IC 306 may be attached to substrate 302 in a recessed and/or non-recessed location.

IC 306 controls operation of tag 102, and transmits signals to, and receives signals from RFID readers using antenna 304. In the example of FIG. 3, IC 306 includes a memory 308, a control logic 310, a charge pump 312, a demodulator 314, and a modulator 316. An input of charge pump 312, an input of demodulator 314, and an output of modulator 316 are coupled to antenna 304 by antenna signal 328.

Demodulator 314 is coupled to antenna 304 by antenna signal 328. Demodulator 314 demodulates a radio frequency communication signal (e.g., interrogation signal 110) on antenna signal 328 received from a reader by antenna 304. Control logic 310 receives demodulated data of the radio frequency communication signal from demodulator 314 on input signal 322. Control logic 310 controls the operation of RFID tag 102, based on internal logic, the information received from demodulator 314, and the contents of memory 308. For example, control logic 310 accesses memory 308 via a bus 320 to determine whether tag 102 is to transmit a logical “1” or a logical “0” (of identification number 318) in response to a reader interrogation. Control logic 310 outputs data to be transmitted to a reader (e.g., response signal 112) onto an output signal 324. Control logic 310 may include software, firmware, and/or hardware, or any combination thereof. For example, control logic 310 may include digital circuitry, such as logic gates, and may be configured as a state machine in an embodiment.

Modulator 316 is coupled to antenna 304 by antenna signal 328, and receives output signal 324 from control logic 310. Modulator 316 modulates data of output signal 324 (e.g., one or more bits of identification number 318) onto a radio frequency signal (e.g., a carrier signal transmitted by reader 104) received via antenna 304. The modulated radio frequency signal is response signal 112, which is received by reader 104. In an embodiment, modulator 316 includes a switch, such as a single pole, single throw (SPST) switch. The switch changes the return loss of antenna 304. The return loss may be changed in any of a variety of ways. For example, the RF voltage at antenna 304 when the switch is in an “on” state may be set lower than the RF voltage at antenna 304 when the switch is in an “off” state by a predetermined percentage (e.g., 30 percent). This may be accomplished by any of a variety of methods known to persons skilled in the relevant art(s).

Charge pump 312 (or other type of power generation module) is coupled to antenna 304 by antenna signal 328. Charge pump 312 receives a radio frequency communication signal (e.g., a carrier signal transmitted by reader 104) from antenna 304, and generates a direct current (DC) voltage level that is output on tag power signal 326. Tag power signal 326 is used to power circuits of IC die 306, including control logic 320.

Charge pump 312 rectifies the radio frequency communication signal of antenna signal 328 to create a voltage level. Furthermore, charge pump 312 increases the created voltage level to a level sufficient to power circuits of IC die 306. Charge pump 312 may also include a regulator to stabilize the voltage of tag power signal 326. Charge pump 312 may be configured in any suitable way known to persons skilled in the relevant art(s). For description of an example charge pump applicable to tag 102, refer to U.S. Pat. No. 6,734,797, titled “Identification Tag Utilizing Charge Pumps for Voltage Supply Generation and Data Recovery,” which is incorporated by reference herein in its entirety. Alternative circuits for generating power in a tag, as would be known to persons skilled in the relevant art(s), may be present. Further description of charge pump 312 is provided below.

It will be recognized by persons skilled in the relevant art(s) that tag 102 may include any number of modulators, demodulators, charge pumps, and antennas. Tag 102 may additionally include further elements, including an impedance matching network and/or other circuitry. Furthermore, although tag 102 is shown in FIG. 3A as a passive tag, tag 102 may alternatively be an active tag (e.g., powered by battery) or a passive/active tag.

FIG. 3B shows several example types of barcodes encoding various amounts and types of data. The example barcodes shown are a 2D PDF417 barcode 152a, a Maxicode 152b, and a linear barcode 152c. PDF417 is a stacked linear bar code format used in a variety of applications, primarily transport, identification cards, and inventory management. PDF stands for Portable Data File. The PDF417 format was developed by Symbol Technologies. Maxicode is a public domain, machine readable symbol system originally created and used by United Parcel Service. It is generally used for tracking and managing the shipment of packages. Maxicode is a 1 inch square having a bullseye in the middle surrounded by a pattern of hexagonal dots. A linear or ID barcode stores information in the widths and spacings of the printed parallel lines.

For ease of discussion, embodiments are described herein in the context of RFID. As would be appreciated by persons of skill in the art, aspects of the described embodiments are applicable to other types of identification technologies including barcodes and other forms of symbology.

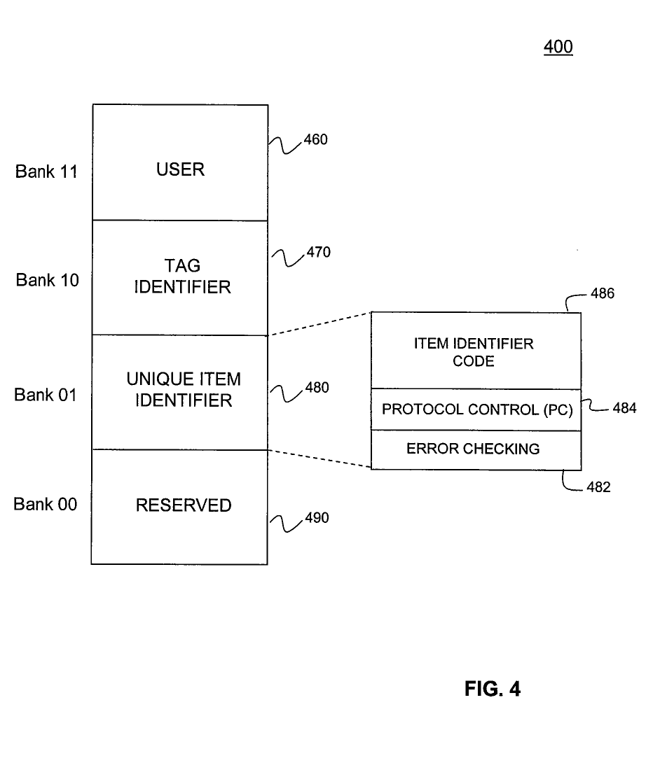

RFID tag memory 308 is typically a non-volatile memory, but can alternatively be a volatile memory, such as a DRAM. Memory 308 stores data, including an identification number 318. In a Gen-2 tag, tag memory 308 may be logically separated into four memory banks. FIG. 4 depicts an exemplary logical memory map 400 for a Gen-2 tag memory 308. Tag memory 308 includes a user memory bank 460 (bank 11), a tag identifier bank 470 (bank 10), a user item identifier bank 480 (bank 01), and a reserved bank 490 (bank 00). Each bank may have any number of memory words. Additionally, the format of one or more memory banks may be established by an industry, governmental, standards, or other similar type of organization.

User memory bank 460 is configured for user-specific data storage. User memory bank 460 is described in further detail below. Tag identifier (TID) bank 470 is configured to store identification information for a tag. For example, TID bank 470 may store an allocation class identifier for the tag and information regarding the unique commands and/or optional features supported by the tag. Unique Item Identifier (UII) bank 480 is configured to store an error checking code 482 (e.g., a CRC-16), protocol control (PC) bits 484, and an item identifier code 486. In an embodiment, PC bits 484 include one or more application family identifier (AFI) bits (e.g., PC bit 17). Item identifier code 486 may identify the object to which the tag is attached. Reserved bank 490 is configured to store the kill and access passwords for a tag.

### User Memory Bank

This section describes an exemplary format definition for a user memory bank 460 in RFID tags (e.g., in ISO 18000-6C tags). The format may be used when encoding user data according to specifications defined by another standards organization (such as EPCglobal). The exemplary format is designed to maintain basic backward compatibility with tags formatted according to a specific standard(s) (e.g., ISO/IEC 15962-formatted tags), but offers increased encoding efficiency. The user memory format and associated encoding and decoding methods described herein are extensible to memories of any size, but bit efficiency may be optimized for memories under 1K bits. Regardless of available memory sizes, air-interface Write and Read times need to be minimized. It is assumed that encoding or decoding time using today's CPUs will be insignificant compared to air-interface time. According to one embodiment of the invention, a solution can utilize a fairly complex encoding and decoding algorithm if it minimizes the number of encoded bits for a given data set that need to be transferred over the air interface.

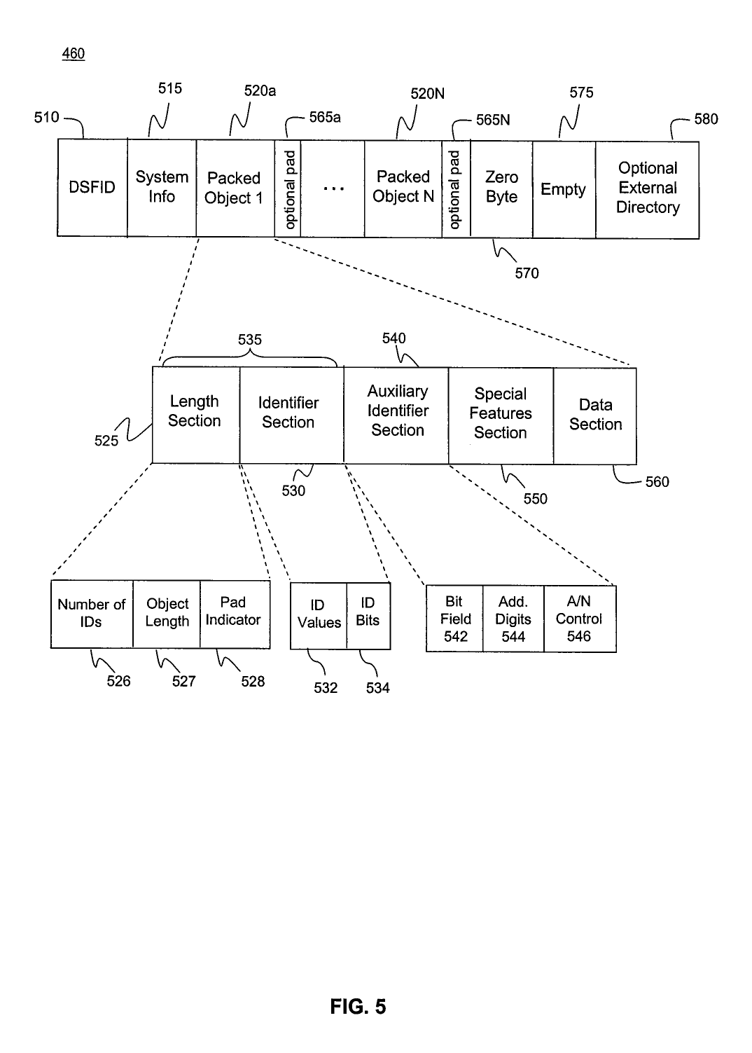

FIG. 5 depicts a high-level format for user memory bank 460 of an RFID Packed Object tag, according to embodiments of the invention. User memory bank 460 includes an optional data storage format identifier (DSFID) 510, a system information field 515, one or more Packed Objects 520a-n, an optional zero byte 570, an optional empty field 575, and an optional external directory 580. Optional pads 565a-n may be included between any two Packed Objects 520 or after the last packet object 520n and zero byte 570. Optional pads 565 are used for aligning various parts of user memory bank 500. Optional pads 565 are signaled by using an otherwise-invalid pattern in the initial bits (e.g., initial 6 bits) of what would be the second or subsequent Packed Object 520. For example, optional pads 565a may be used to align the next Packed Object 520b. Such alignment can be useful for many purposes, including simpler access using word-aligned reads, better ability to apply passwords or otherwise control access to complete Packed Objects 520a-n, and more efficient indexing and random access to Packed Objects 520a-n via use of an optional external directory 580.

High level discussion of DSFID 510 and Packed Objects 520a-n are provided below. For a detailed discussion of DSFID 510 and Packed Objects in general, see U.S. Pat. No. 6,196,466, filed Jun. 9, 1999, entitled “Data Compression Method Using Multiple Base Number Systems” (hereinafter the '466 patent); U.S. patent application Ser. No. 11/806,050, filed May 29, 2007, entitled “Data Format for Efficient Encoding and Access of Multiple Data Items in RFID Tags” (hereinafter the '050 application); and U.S. patent application Ser. No. 11/806,053, filed May 29, 2007, entitled “Data Format for Efficient Encoding and Access of Multiple Data Items in RFID Tags” (hereinafter the '053 application), each of which are incorporated by reference herein in its entirety.

User memory bank 460 may include an optional zero byte 570 in embodiments which do not include a parser capable of parsing the packet object format described herein. In these embodiments, a zero-value is encoded in zero byte 570. Although depicted after the last Packed Object 520n in FIG. 5, the zero byte may alternatively precede the first Packed Object 520a. The zero-valued zero-byte looks like a terminating Precursor to these parsers (e.g., a standard ISO parser).

User memory bank 460 may also include a system information section 515. System information section 515 may include hardware or system information about the tag and/or sensor information if the tag has an associated sensor.

User memory bank 460 may also include a variable number of empty bytes 575 followed by an optional external directory 580. Although depicted as following empty bytes 575, external directory 580 may be located at the front of user memory bank 460 or at the end of the series of Packed Objects 520. Optional external directory is described in further detail below. Note that one or more bytes may be included following the DSFID 510. For example, these bytes may be reserved for a specific current use or marked for future use.

Note that Packed Object tags can be intermixed in a tag population with non-Packed Object tags. This highlights the backward compatibility feature of the user memory bank format described herein. Therefore, Packed Object tags, if unformatted, begin with a first byte of zero. If formatted, Packed Object tags include the necessary set of information to indicate their configuration (i.e., Packed Object) to a reader.

### Data Storage Format Identifier (DSFID)

DSFID 510 includes information related to the organization and encoding of data in user memory bank 460. For more detail on the DSFID, see the '466 patent and the '050 and '053 applications referenced elsewhere and incorporated herein.

DSFID 510 includes information related to the organization and encoding of data in user memory bank 460. An example data system that may be utilized in a Packed Object 520 is application identifiers (AIs). AIs are a finite set of identifiers used to connect physical and logical things to information about them. Each AI includes a two or more digit prefix used to identify the context of the data (e.g., serial shipping container code, global trade item number, etc.). AIs are typically assigned and maintained by a national or international standards setting or trade organization (such as GS1). Another data system that may be utilized is data identifiers (DIs) (also referred to as “FACT data identifiers”). A DI may be a single alphanumeric character or an alphanumeric character prefixed by one or more numeric characters. DIs are also typically assigned and maintained by a national or international standards setting or trade organization (such as ANSI). As would be appreciated by persons of skill in the art, data systems other that AI and DI could be used in the present invention.

Various embodiments of the present invention may use different DSFID formats. For example, an embodiment may use a DSFID which favors AIs, allowing DIs to be encoded at a lower efficiency. In another exemplary embodiment, a DSFID can be used which favors DIs, allowing AIs to be encoded at a lower efficiency. In a further example, an embodiment may use a DSFID in which all AIs and DIs use the same compaction and general structure.

Special Features Indication

Because the DSFID 510 may also be used to signal the presence of additional information in user memory, special flags are defined. For example, the appearance of a predefined bit pattern (e.g., ‘100’) may be used to signal the presence of a special features section 550. The presence of this optional special features section 550 is signaled by using an otherwise-invalid pattern in the initial 3 bits of the packed object 520. In a further example, the appearance of a predefined bit pattern in the first six bits of a packed object is used to signal the presence of an optional external directory 580 (as distinct from the mini-directory 535 including length 525 and identifier 530) that is inherently part of every packed object 520). The presence of this optional external directory 580 is signaled by the presence of a predefined bit pattern at a predefined memory location. For example, the optional external directory may be signaled by using an otherwise-invalid pattern in the initial 6 bits of what would be the first packed object 520a.

### Packed Objects

As illustrated in FIG. 5, an exemplary Packed Object includes a length section 525, an identifier section 530, an optional auxiliary identifier (Aux ID) section 540, an optional special features section 550, and a data section 560. In an embodiment, the sections of packet object 520 are bit-aligned (that is, no pad bits between sections are required). One or more sections of a packet object 520 may have a variable number of bytes.

Length section 525 indicates the overall length of the packet and indicates how many identifier values (e.g., AIs) are encoded in the packet. Length section 525 includes two length vectors (number of IDs field 526 and object length field 527) and a flag (pad indicator 528). Identifier (ID) section 530 includes a listing of one or more IDs. Aux ID section 540, when present, encodes additional bits that are defined for some classes of IDs. These bits aid data compression but do not contribute to defining the ID. Data section 560 represents the concatenated and compressed data from the AIs and other IDs.

FIG. 5 also depicts an exemplary Identifier (ID) Section 530 and an exemplary Auxiliary Identifier (Aux ID) section 540, according to embodiments of the present invention. ID section 530 includes an ID values subsection 532, and an ID bits subsection 534. Aux ID section 540 includes a bit field portion 542, an additional digit portion 544, and an optional A/N control portion 546.

### Improvements to Existing Fixed Formats

The following discussion concentrates on RFID tags. However, the description is applicable to any read/write media in general, and the reading portions are applicable to read-only media (e.g. simple barcodes and readers).

Fixed-format schemes can achieve improved encoding efficiency, at the expense of flexibility, when an industry or an application develops a “profile.” A profile is a carefully-defined set of data items that should be present on all data carriers used in that industry or application. Because a predetermined set of data items are always encoded in a predetermined order, the identifiers need not be encoded (only their associated data strings are encoded). A variable-format scheme using the information defined in such a profile achieves the goal of minimizing the size of required tag memory without sacrificing flexibility.

Further, in the case of read-write media, the amount of read/write transmissions could be reduced if an equivalent of the EPCGlobal Gen 2 Select command could be used in variable format schemes. The Gen 2 Select command pre-selects which media will respond to an inventory round based on the presence or absence of specific data elements in memory. Existing Select commands as defined for RFID apply a matching bit-pattern “mask” to the tag's user memory bank at a particular location. However, in a variable format memory, the exact placement of the bits denoting that identifier are not at a fixed location. Thus, existing interrogators cannot determine in advance which masking pattern will select a target identifier in variable format schemes.

Using the Select command or its equivalent on variable format user memory storage devices provides several advantages. For example, the Select command could be used to “silence” a subset of a RFID tag population that does not contain a data item of interest. This significantly reduces the amount of transmission air time needed to extract that data item from the remaining tags. Similarly, silencing the subset of the tag population that does have the item significantly reduces the amount of air time needed to find and program those tags without the data item.

Variable format schemes may also be improved by a redefinition that allows data items to be deleted or modified without rewriting all the subsequent data in memory. This can be achieved without invalidating whatever directory structure is defined for the format (e.g., for Packed Objects, the mini-directory 535).

The first publication of ISO/IEC 15961 and 15962 described an optional Directory structure that improved the ability of its defined variable-format encoding scheme to meet some of the above goals, but both the variable format and the Directory itself achieved flexibility at the cost of significant encoding overhead, thus mitigating their usefulness. Moreover, the optional ISO directory was defined to “grow downwards” from the end of memory as new data items were added to the start of memory. As a consequence, at least two Read operations are required to determine the presence or absence of specific data items (i.e., one Read targeting the start of tag memory to determine that a directory is present, plus at least one read at the end of tag memory to fetch the directory contents).

The Packed Objects methods discussed in the '050 and '053 applications are a significant improvement, but have two functional limitations. First, although all of the ID) information is gathered at the front of the Packed Object in an efficient mini-directory 535, the exact order and placement of identifiers is still variable. Thus, the Gen 2 Select command or its equivalent cannot be used to preselect which tags will respond to an inventory round based on the presence or absence of a specific data identifier. Additionally, while optimally compacting the data when it is encoded, the format leaves no provisions for editing a Packed Object other than rewriting it in fall.

Embodiments of the present invention include two new basic encoding mechanisms that can be applied separately or together to various encoding formats, including Packed Objects. These two mechanisms are referred to as “ID Map” and “Addendum”.

An ID Map represents a set of data identifiers that are encoded in a data carrier or in a defined subset of a data carrier, such as a Packed Object. An ID Map includes a series of bits, whose length corresponds to the number of ID Values or Identifiers defined in a data system. The state of each bit in the ID Map indicates whether the corresponding identifier is present or absent. ID Maps and ID Map based Packed Objects (IDMPOs) are described in detail below. ID Value based Packed Objects (IDVPOs), which use an ID Values list instead of an ID Map, are also described in detail below.

In addition or alternatively, an Addendum section may be added to the end of encoded data or elsewhere to implement Delete, Add, and/or Modify editing operations. The Addendum enables modification of selected data items within variable format encoded data formats such as a Packed Objects with no need to rewrite any of the other data items in the encoded data set.

### ID Map

An ID Map may be viewed as a representation of the presence and absence of a set of identifiers. Embodiments of ID Map can take a variety of forms and are applicable to various fixed and variable format data. The following description is based on an exemplary embodiment of an ID map in a Packed Object, but ID maps are applicable to other formats.

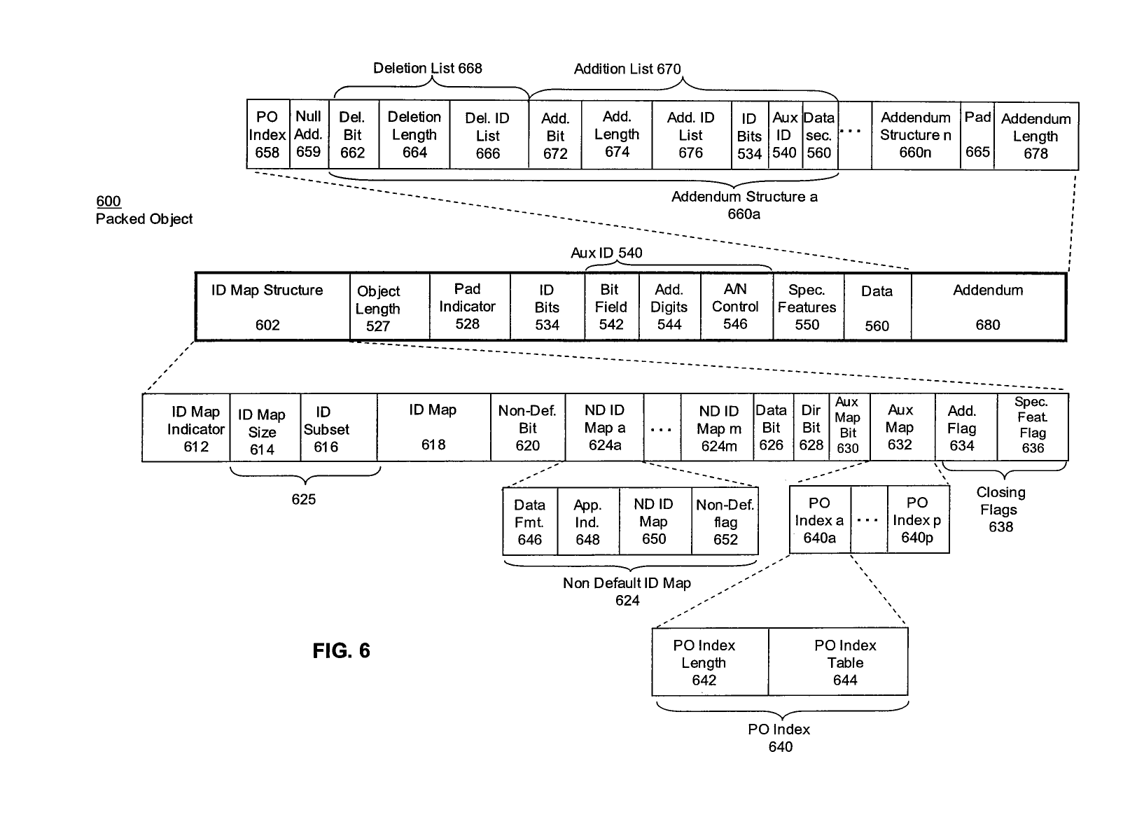

FIG. 6 illustrates an example embodiment of an ID map embedded in a Packed Object 600. Packed Object 600 is a modification of the Packed Object described in the '050 and '053 applications. Packed Object 600 includes an example ID map section 602 and an example Addendum section 680. Addendum section 680 is in detail below. ID Map section 602 does not require the presence of Addendum section 680; also, addendum section 680 does not require the presence of ID Map 602 nor any other optional Packed Object 600 element.

ID map section 602 includes an ID map indicator 612, an ID map size 614, an ID subset 616, an ID map 618, a non-default ID map bit 620, one or more non-default ID maps sections 624a-624n, a data bit 626, a directory bit 628, an aux map bit 630, aux map 632, an addendum flag 634, and a special features flag 636.

All fields referred to as “bit or “bits” (e.g., “directory bit 628,” “aux map bit 630,” etc.) may actually be stored in any convenient storage location or size. Just as a single “flag” stores only a “True” or “False” but may be implemented easily as a single bit or as a storage location of one or more bytes, a “bit” field may be implemented in a storage location of any size. In examples throughout this document, these “bit” and “bits” fields are described as a single bit or series bits, respectively, for clarity. The actual implementation, however, is not so limited. In some embodiments, “bit” and “bits” fields are implemented as an actual bit or series of bits for efficiency reasons. In other embodiments, a “bit” or “bits” field is implemented in storage locations of other sizes.

In this exemplary embodiment, where ID map section 602 is encoded for a Packed Object 600, it is followed by an object length 527 and a pad indicator 528 and then may be followed by the other sections as defined for Packed Objects without an ID map. The NumberOfIDs and ID Value list, however, do not need to be encoded in an IDMPO.

There are two types of IDMPOs—Data IDMPOs and Directory IDMPOs. Both types of IDMPOs may encode data items. A difference between Data and Directory IDMPOs is that a Directory IDMPO's ID map section 602 may include indications of data items encoded in subsequent Packed Objects, and a Data IDMPO's ID Map section 602 only reflects items encoded in that Packed Object itself. If a Directory IDMPO contains any data items, then it may include an otherwise-optional PO Index field 640 to distinguish which of the data elements on its ID Map 618 are contained within it as opposed to being contained elsewhere.

In the following text, components of an exemplary embodiment of an ID Map section 602 will be described.

### ID Map Indicator

Embodiments of ID Map are not the most bit-efficient representation of a set of identifiers under all circumstances. Thus, ID Maps may be implemented as an optional, rather than a required, encoding feature. A format indicator may indicate whether an ID Map or a different representation—such as a list of ID Values—was chosen by the encoder.

To indicate the presence of an ID Map in data formats where the ID Map is optional, an ID Map Indicator 612 may be used. There are several options for ID Map indicator 612.

In an embodiment, the ID Map approach is set as the default ID encodation. In this embodiment, an explicit flag or switch is encoded to indicate an alternate choice of ID Value or verbatim encoding. Conversely, an ID Map may not be preferred when usually encoding small messages (e.g., those containing only a one or two data items). The default may be set to ID Value encodation for small messages, thus incurring extra overhead to indicate the alternate choice of an ID Map. The remaining indicator options in this list assume that ID Map encoding is not the default. These options are examined within the context of Packed Object formats, but similar embodiments apply to other formats.

In an alternative embodiment, a particular ID Value is reserved to indicate a latch to ID Map encoding. Packed Objects containing a single-entry ID list—where the single ID entry is the latch to ID Map encoding—would always begin with the same bit pattern indicating use of an ID Map, followed by the ID Map itself. This approach is fully compatible with Select operations.

In a further embodiment, one or more flag bits at the front of every Packed Object are included to indicate whether ID Map or ID Value encoding is used. This approach is also amenable to Select operations. However, it adds one bit of overhead to every Packed Object (regardless whether it uses an ID Map or not).

In another embodiment, a Packed Objects Special Features Flag is immediately followed by one or more flag bits indicating various optional features, including whether ID Map encoding is used. IDMPOs using this option may begin with the same pattern and thus would be amenable to Select operations. For example, this approach could be implemented with the following additions to the prior definition of a Packed Object's Special Features Flag.

In this example, an initial flag pattern is reserved and is followed by at least one more bit. It is not followed by the NumberOfIDs indicator, as in the '050 and '053 patents' Packed Objects descriptions. For example, the additional bit(s) following the initial flag pattern (e.g., ‘100’) may include an additional three-bit pattern (e.g., ‘100’) signifying a repeating Pad pattern (e.g., of “100100 . . . ”). If a pattern of “100100” occurs where the first Packed Object of a memory would normally appear, it does not indicate padding, but instead indicates the presence of an external Directory. If present, the external Directory may be structured as defined within ISO/IEC 15961's “Directory Access Method” and may be encoded elsewhere in memory (i.e., not within a Packed Object). If this leading pattern is encoded, then the first Packed Object in memory immediately follows the pattern. An example pattern is “100100xx” where “xx” represents any additional bits, including those that may be defined in a standard, such as a revision to 15961 which refines the Directory structure of the “Directory Access Method.”

An additional pattern (e.g., three bits ‘0as’) signifying that the Packed Object uses standard ID Value encoding (i.e., is a IDVPO), and that one or both of an Addendum and/or a Special Features section are encoded later in the Packed Object may be included. For example, an Addendum could be indicated as present if ‘a’ as a first value (e.g., ‘1’) and absent if ‘a’ is a second value (e.g., ‘0’). An EBV-8 Special Features Section could be indicated as present if ‘s’ has a first value (e.g., ‘1’) and absent if ‘s’ is a second value (e.g., ‘0’). An additional pattern (e.g., two bits set to a specific value such as ‘11’) indicating a Packed Object using an ID Map section instead of ID Value encoding (i.e., is a IDMPO) may additionally or alternatively be included.

The last option for indicating ID Map encoding adds no overhead to Packed Objects unless they use special features. Under this approach, an exemplary IDMPO 600 may begin with ID Map Indicator 612 of a fixed five-bit pattern ‘10011’.

Application Indicator

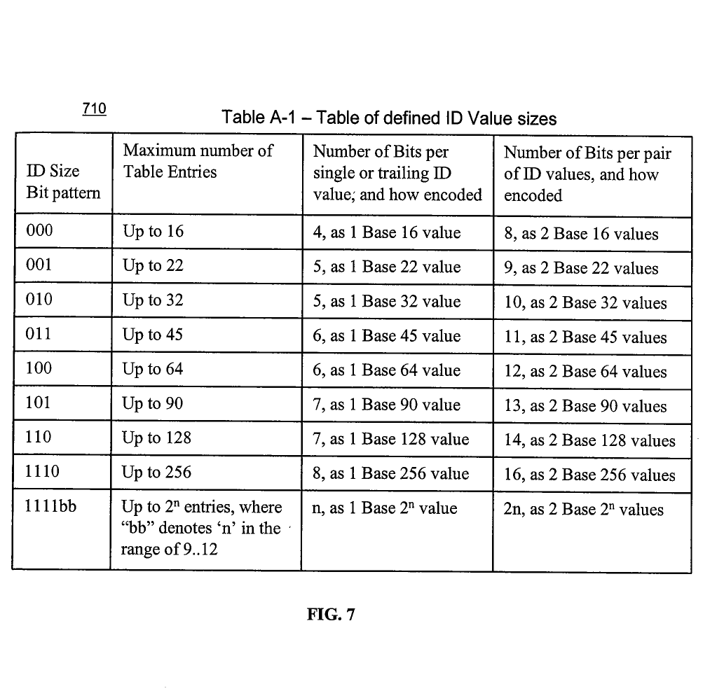

If an ID Map 618 is present, ID Map Indicator 612 may be followed by an application indicator 625 including an ID map size 614 pattern (e.g., three bits) and a ID Subset 616 pattern (e.g., three bits). ID map size 614 denotes the ID Map's size (e.g., bit length), which may be one of the sizes defined Table 710 (Table A-1) shown in FIG. 7 (such as 16 bits, or 22 bits, and so on). In an embodiment, the largest length supported for an ID Map is 256 bits (using a pattern of ‘111’, not ‘1110’ as listed in Table 710). An ID Map's size is encoded, because a decoding system, if unaware of the details of the registered data format indicated in the DSFID, would be unable to parse an object length 527 field of an IDMPO 600 without knowing the length of the ID Map section 602 (e.g., how may bits prior to the object field must be skipped in the IDMPO 600).

ID map size 614 is followed by an ID Subset 616 pattern (e.g., three bits). A registered data format's primary base table may be used by the current Packed Object, and may be indicated by an encoded ID subset 616 (e.g., three bits set to ‘000’). However, additional alternate base tables may be defined in the registration, each alternate base table with its own ID map size, and a choice from among these can be indicated by the encoded ID subset 616 pattern (e.g., with three to seven bits). This feature can be used to define smaller sector-specific or application-specific subsets of a fall data system, thus substantially reducing the size of the encoded ID Map.

### ID Map

In an embodiment, an ID Map 618 has a length defined by ID map size 614, and indicates the presence or absence of encoded data items corresponding to entries in a specific primary or alternate base table. The choice of base table is indicated by the encoded combination of DSFID 510 and application indicator 625 (i.e., ID map size 614 and ID subset 616).

In an embodiment of a Directory IDMPO's ID map 618, each bit indicates (e.g., by having a value of ‘1’ or ‘0’) whether one and only one of the following Data Packed Objects in the same memory bank contains a valid data item corresponding to an entry in the associated registered Base Table. Optionally, a Directory Packed Object may further indicate which Packed Object contains each data item (see the description of the optional AuxMap 632 section below).

In a Data IDMPO's ID Map 618, each bit indicates whether the IDMPO contains one and only one valid occurrence of the data item corresponding to an entry in the associated registered Base Table (e.g., by having a first value such as of ‘1’ to indicate it does and by having a second value, such as ‘0’, to indicate it does not). This valid occurrence may be in the body or in the Addendum 680 of the IDMPO. One or more data entries may be encoded in the IDMPO, but marked “invalid” by an entry in the Addendum 680 section. Invalid entries are not reflected as a valid occurrence (e.g., there is not a ‘1’ bit in that position) in the ID Map-unless a valid version of the same entry is encoded in the Addendum 680 of the same Packed Object.

Data items encoded in the body (e.g., data section 560) of a Data IDMPO appear in the same relative order in which they are listed in the associated Base Table. However, additional “out of order” data items may be added to an existing IDMPO by appending an Addendum to the Object.

In contrast to a Data IDMPO, there is no required correlation between the order of bits in a Directory's ID Map and the order in which these data items are subsequently encoded in memory within a sequence of Packed Objects. Instead, a Directory IDMPO may optionally indicate which subsequent Data Packed Object contains each data item. See the AuxMap Section description below for more detail.

An ID Map 618 might not include the information conveyed by ID Bits 534 as would typically be defined in a secondary table, and so only a single occurrence of a data item corresponding to a given base table entry can be represented in the body of a Data Packed Object. One or more subsequent occurrences, however, may be encoded in Addendum Structure(s) each using different ID Bits 534 qualifiers to denote that they are different data items. An ID Map 618 does not correspond to a secondary table instead of a base table unless the registration specifically assigns an ID subset pattern to the secondary table.

### Optional Non-Default ID Map Sections

In an embodiment, zero or more non-default ID map sections 624 are included in ID map section 602. In an embodiment, a non-default ID map section 624 follows a non-default flag 620 (e.g., one bit set to a first value such as ‘1’). This sequence may optionally repeat. Thus, in an embodiment, the first non-default flag 620 is mandatory, and each non-default map section 624a-624n has a trailing non-default flag 652a-652n. The last non-default map section 624n in the series sets the non-default flag 652n to indicate that there are no more non-default maps sections 624.

In an embodiment, non-default ID Map section 624 includes: a data format field 646, an application indicator 648, a non-default ID map 650, and a non-default flag 652. Data format field 646 may indicate the non-default data format, which may be registered per ISO/IEC 15961-2. In an embodiment, data format field is a 16 bit field. Application indicator 648 may have the same format as the application indicator 625 described above—i.e., it may include an ID map size pattern field (e.g., three bits) and a ID Subset field (e.g., three bits).

Non-default ID map 650 indicates non-default data items encoded in the current IDMPO. In an embodiment, the same non-default data items are indicated in the IDMPO's default ID map 618. This is because encoding of non-default data items occurs through some mechanism defined in the default base table, such as direct ID value reference, verbatim encoding, etc. The relative encoded position within the current IDMPO of such non-default data items is indicated by the corresponding entry in default ID map 618, not non-default ID Map 650.

### Data, Directory, and AuxMap Indicator Bits

In an embodiment, a set of three indicator bits (a data bit 626, a directory bit 628, and an aux map bit 630) is encoded following the default ID map 618 and the non-default ID Map section(s) 624a-624n. Each field indicates the presence or absence of the respective feature in the IDMPO (e.g., indicates the presence by having a first value such as ‘1’ and the absence by having a second value such as ‘0’).

In a further embodiment, data bit 626 and directory bit 628 in an exemplary Data IDMPO are set to the first and second values (e.g., ‘1’ and ‘0’) respectively because the Data IDMPO is a PO of type “data” and does not have a directory. Similarly, the directory bit 628 of an exemplary Directory IDMPO is set to a first value (e.g., ‘1’), but the data bit 626 may be set to either the first value or the second value (e.g., ‘0’ or ‘1’) because the Directory IDMPO is a PO of type “directory”, but the Directory IDMPO may or may not have data itself. The third bit, aux map bit 630, may be set to either the first or second value regardless of the setting of data bit 626 and directory bit 628. Thus, the following example scenarios are possible:

In a first example, a data storage device (e.g., an RFID tag) is formatted with an empty directory structure encoded immediately after the DSFID, then one or more Data Packed Objects is added behind the directory structure over time.

In a further example, a single Data IDMPO is initially encoded on a data storage device (e.g., an RFID tag), and later optionally a number of data items are added to it using an Addendum section or structure, and at an even later point in time the Data IDMPO is converted to a Directory IDMPO. The IDMPO's ID Map is “promoted” from internal-only to a summary directory for the entire tag by changing the directory bit 626 (e.g., from ‘0’ to ‘1’), and unless an AuxMap section 632 containing a PO Index 640 was already encoded (in anticipation of this conversion), the conversion also requires adding a PO Index section 640 (defined in the AuxMap description below) to it as an Addendum. This new section indicates whether each item marked as present (e.g., with a ‘1’) in this Packed Object's ID Map is actually encoded within this Packed Object or in a subsequent object. A decoding system may understand from the resulting bit settings (indicating a Directory Packed Object that does contain data but that does not contain an AuxMap 632) that a PO Index section 640 has been added as an Addendum.

In another example, additional Directory Packed Objects (see the AuxMap description below) are “daisy chained” in order to expand the number of Packed Objects that can be distinguished by the Directory structure.

Optional AuxMap Section

An exemplary embodiment of an AuxMap 632 optionally allows a Directory IDMPO's ID Map 618 to indicate not only presence/absence of all the data items on the storage device (e.g., RFID tag), but also which Packed Object encodes each data item. An AuxMap indicator bit 639 indicates whether an AuxMap 632 is encoded (e.g., set to a first value, such as ‘1’, if the AuxMap is encoded, and to a second value, such as ‘0’ if not). In an embodiment, optional AuxMap 632 contains one PO Index Field 640 for each of the ID Maps (default ID map 618 and non-default ID maps section 624) that precede the AuxMap section.

A PO Index 640 includes a PO Index Length 642 and a PO Index Table 644. In an embodiment, PO Index Length 642 indicates the number of index bits encoded for each entry in the PO Index that immediately follows this field. In an exemplary embodiment, PO Index Length is two bits. A PO Index Length may indicate that there are no PO Index Tables following (e.g., a first value such as ‘00’ means that no PO Index Table follows, a second value such as ‘01’ means that one PO Index table follows, etc.). Note that a data IDMPO may have been converted to a Directory IDMPO as described earlier.

An exemplary PO Index Table 644 consists of an array of bits, where each entry (of one or more bits depending on the POIndexLength) indicates by relative order which Packed Object contains each data item indicated by the corresponding “item present” entry in the preceding default or non-default ID Map. In an embodiment, special definitions apply to certain values encoded (e.g., the lowest and highest values that each index can encode). For example, a PO Index Table entry of zero may refer to the current Packed Object containing this section, a value of one refers to the next Packed Object, and so on. The highest Index value ‘n’ (e.g., ‘n’ may have a value of seven if PO Index Length indicates a three bit PO Index Table entry length) indicates that the associated data item is encoded in a Packed Object whose relative index (position in memory) is ‘n’ or higher. This definition allows Packed Object ‘n’ to be defined as a “daisy-chained” second Directory Packed Object, whose ID Map indicates (e.g., with a first value such as ‘1’) only those items encoded within it, or encoded still higher in memory in a subsequent Packed Object.

Closing Flags

The ID Map section ends with Closing Flags field 638, including an Addendum Flag 634 and a Special Features Flag 636. In an embodiment, Addendum Flag indicates whether or not there is an Addendum encoded at the end of the Packed Object.

Special Features Flag 636 indicates whether or not a Special Features Section 550 is encoded later in the Packed Object. For more details on special features section, see the '050 and the '053 applications referenced elsewhere herein.

### ID Map Example Applications

The following subsections illustrate some applications demonstrating some features of embodiments of ID Map, but are not meant to be exhaustive.

Using an Embodiment of ID Map With Select Operations for Efficient Processing of a Population of Tags

An exemplary embodiment of an IDMPO supports a variable choice of identifiers, but indicates the chosen identifiers at a fixed memory location. For example, this embodiment implemented in an RFID Gen 2 tag allows a Gen 2 Select operation on variable contents of User Memory even though the specific layout of data items is not known a priori. Thus an Interrogator can include or exclude tags from an inventory round based on whether or not the tag's User Memory bank contains one or more specific data items, even though the data items may be variable-length and encoded at different physical offsets on different tags in the population.

An ID Map section's structure may minimize the number of Select operations needed to implement this capability. For an application (having support for IDMPOs) of a given data system, the same single fixed bit pattern starting from the leading DSFID may be present at the start of the User Memory bank of every tag in the population conforming to that application. Moreover, that common fixed pattern is immediately followed by the ID Map bits that serve as the tag's presence/absence directory for the application defined by the preceding fixed pattern. Thus, a single Select command will normally be sufficient to select those tags that contain (or lack) a specific subset of one or more identifiers. A further benefit of the defined structure is that the same Select command operates correctly on a population of tags that includes both tags where the encoding system chose to encode all of the user data into a single Data Packed Object (for efficiency), and those tags where the encoding system chose to encode a leading Directory Packed Object (for flexibility).

Alternatively, an application may define its compliant tags to use a combination of a Directory Packed Object at the start of the tag (with a large ID Map, based on the Primary Base Table and of sufficient size to indicate any allowed identifiers within the data system), and a series of Data Packed Objects (perhaps each written by a different trading partner or at a different point in a supply chain or product life cycle), where each of these utilizes a defined Alternate Base Table and a smaller ID Map (or ID Value list).

As each new Packed Object is added, the Directory Packed Objects ID Map may be updated to show the presence of the additional IDs, all referenced to the Primary Base Tables list of indices, and (using the AuxMap section of the directory) updated to show which Data Packed Object contains each identifier that is marked as present. The receiving system will have no difficulty dealing with the fact that the Data Objects may use different indices than the Directory when representing a given data system identifier, nor with the possibility that different Data Packed Objects on the same tag may use different Alternate Base tables from each other, since all components of the encoded system are self-identifying. Under this scenario, it is still true that the same Select mask (operating on the Directory Packed Object's ID Map) will work properly with every tag encoded according to the application rules, even though different tags in the population may actually encode the same data item using different Alternate Base Table IDs.

Using an ID Map Embodiment as a “Quasi-Directory”

An embodiment of an ID Map can form a particularly-efficient quasi-directory for denoting the contents of a storage device (e.g., an RFID tag). A full tag directory structure, as previously known, encodes the address (e.g., memory location) of every data element within the data carrier, which requires the writing of a relatively large number of bits (e.g., roughly 32 bits or more per data item). Inevitably, such an approach also requires reading a large number of bits over the air, just to determine whether an identifier of interest is present on a particular tag. In contrast, when only presence/absence information is needed, using an ID Map at a predetermined location on the data carrier conveys the same information using only one bit per data item defined in the data system. When using ID Value representations of identifiers (which may classify related identifiers under a single value), the entire ID Map can be typically represented in 128 bits or less, and stays the same size when more data items are written to the tag.

Many or most data systems have a rule that a given identifier may only appear once within a single data carrier. This rule, when an embodiment of an ID Map quasi-directory is used with Packed Object encoding of the data, can result in nearly-complete random access for reading data using relatively few directory bits. As an example, an exemplary ID Map directory of one bit per defined ID can be associated with an additional Packed Object Index Table (PO Index Table) using, for example, three bits per defined ID. Using this arrangement, an interrogator could first read the ID Map to determine if the desired data item were present on the tag. If so, it would read the corresponding three PO Index Table bits to determine which of the first eight Packed Objects on the tag contain the desired data item.

Using an ID Map Embodiment to Implement an Industry-Defined “Profile”

An embodiment of an ID Map provides efficient implementation of industry-specific profiles. If an industry or other group agrees to select and register a set of identifiers such that a fully-encoded data carrier should contain at least a quarter of the full set, then an ID Map can be a more space-efficient representation of the ID list than would be achieved by encoding either the identifiers themselves or even their ID Values.

For an example, if a profile contains 16 entries (i.e., it may have a 4-bit index), it is more efficient to use a 16-bit ID Map instead of an ID Values list if more than four of the 16 will ultimately be encoded in an exemplary Packed Object. Using an ID Map allows the tag to be written incrementally, yet always maintain a valid directory of which of the profile's data items are currently present on the tag. Moreover, when utilized within a variable format such as Packed Objects, it supports the efficient encoding of variable-length data items so that worst-case space need not be reserved for each data item.

Editing RFID Tag Data

An embodiment of an ID Map implemented in an RFID tag can work in conjunction with a Packed Object's Addendum section to enable full editing capabilities, while maintaining a completely accurate directory of the Packed Object's contents. This application will be discussed in detail under the description of the Addendum below.

### An Exemplary Packed Object “Addendum” Section (Providing Editing Facilities)

One or more instances of an Addendum at the end of an exemplary Packed Object written to an RFID tag allows various editing operations to be performed on Packed Objects (as long as the tag's memory locations are or can be unlocked). Only a relatively small amount of overhead need be reserved to enable editing operations that may be performed on a Packed Object after subsequent data has been written to the tag. The editing features available through the Addendum section have the goal of minimizing the number of bits that need to be written when performing an editing operation.

Structure of an Exemplary Addendum Section

FIG. 6 illustrates an embodiment of an Addendum section 680. Addendum sections are applicable to many data structures. The current example is illustrated in the context of a Packed Object 600 stored on an RFID tag. This example adequately demonstrates features of the invention to enable other embodiments to be implemented in other contexts.

In an embodiment, an addendum section 680 may be encoded as the final bytes of a Packed Object 600. The length of addendum section 680 is a multiple of a fixed number of bits (e.g., multiples of eight bits). Addendum section 680 includes one or more addendum structures 660a-660n, which may be appended in succession as needed. An addendum length field 678 resides at the end of addendum section 680 and indicates the length of addendum section 680 (e.g., if in addendum section 680 length is multiples of 8 bits, then addendum length 678 may indicate the length in eight bit bytes). In an embodiment, addendum length field is an EBV-8 field, and the final EBV-8 pattern (the only one with its extension bit set to a first value such as ‘0’) occupies the last eight bits of Packed Object 600.

Within addendum section 680, the first (e.g., leftmost) addendum structure 660a begins at the location indicated by addendum length 678, and, if there is a subsequent addendum structure 660b, it begins at the next free bit location after the previous addendum structure 660a. Additional addendum structures 660 may be added after 660b, thus overwriting the previously-encoded addendum length 678 and any pad bits that may have preceded it. Zero or more pad bits in optional pad 665 may follow final addendum structure 660n, so that trailing addendum length 678 occupies the final portion (e.g., final 8-bit byte(s)) of Packed Object 600).

An encoded addendum section 680 begins with an optional PO index section 658 (present only under special conditions as described below) and a null addendum flag 659.

PO Index section 658 need only be present if the parent data structure (e.g., Packed Object 600) uses an ID Map rather than an ID Value List (e.g., is an IDMPO and not an IDVPO), has been converted from a Data to a Directory object, and has no encoded AuxMap 632 section. In an embodiment, this condition is indicated by a certain combination of flag bits near the start of the data structure (e.g., Packed Object 600), as was described above. If present, a PO Index section 658 consists of a series of PO Index Fields 640 (as were previously described in the context of Aux Map 632), one PO Index Field 640 for each of the ID Maps that are encoded in Packed Object 600 (i.e., default ID map 618 and non-default ID map sections 624a-624m).

If Null Addendum flag 659 is set to a first value (e.g., ‘1’), then the subsequent bits in addendum section 680 are a series of insignificant pad bits (which may be any value, e.g., ‘1’ or ‘0’) so that the overall length of addendum section 680 matches that specified by the trailing Addendum Length 678. If Null Addendum flag is not set (e.g., is a second value such as ‘0’), then an Addendum section 680 has been filled with addendum structures 660.

A exemplary embodiment of a non-null Addendum section 680 consists a series of one or more addendum structures 660a-660n, each addendum structure 660 having a deletions list 668 and an additions list 670.

An exemplary deletions list 668 includes a deletions bit 662, an optional deletions length 664, and an optional deletion ID list 666. In an embodiment, deletions bit 662 is a single bit which indicates whether deletions length 664 and deletion ID list 666 follow. In an embodiment, optional deletions length 664 is a extensible bit vector (e.g., EBV-3) field which indicates the number of ID values encoded in optional deletion ID list 666. In an embodiment, the deletions ID list 666 is formatted the same as the ID values section 532 of a standard Packed Object 520 as illustrated in FIG. 5. In another embodiment, deletions ID list 666 is formatted the same as ID Section 530 of standard Packed Object 520.

Each ID value in deletions ID list 666 matches an ID Value for a data item that has been encoded at some prior point in the current Packed Object 600 (either in its body, or in a previous addendum structure 660). Data items associated with identifiers on this list are considered “invalid” even though encoded in Packed Object 600, and may be replaced by the first appearance of a new data item with the same identifier, at any subsequent point in this or subsequent Packed Objects 600. That new instance of the data item may itself be marked invalid, by its appearance on a subsequent deletions list 668.

An exemplary additions list 670 includes a additions bit 672, an optional additions length 674, and an optional addition ID list 676. In an embodiment, additions bit 672 is a single bit, which indicates whether additions length 674 and additions ID list 676 follow. In an embodiment, optional additions length 664 is a extensible bit vector (e.g., EBV-3) field which indicates the number of ID values encoded in optional additions ID list 676. In an embodiment, the additions ID list 676 is formatted the same as the ID values section 532 of a standard Packed Object 520 as illustrated in FIG. 5. In another embodiment, additions ID list 676 is formatted the same as ID Section 530 of standard Packed Object 520 as illustrated in FIG. 5.

Optionally, following an additions list 670 are any ID Bits 534, Aux ID sections 540, or data sections 560 invoked by the IDs in additions list 670, in the same manner as they would be in the body of a standard Packed Object 520. If one or more of the ID values in additions list 670 invokes an A/N subsection of a data section 560, then an EBV-6 Character-Map Length Indicator, similar to what was described for a “split A/N” in the original Packed Objects description (i.e., A/N control 546 in Aux ID 540) precedes the A/N subsection of data section 560 of Addendum Structure 660.

Indicating an Editable Packed Object With an Addendum Flag

In an embodiment, an addendum flag 634 may be included to indicate whether a Packed Object 600 has an addendum section 680, thus signaling the capability for future editing of Packed Object 600. If a data structure uses a variable-length ID Values list instead of an ID Map (e.g., is an IDVPO), then this flag functionality may be encoded by prefacing the Packed Object with an addendum flag equivalent to addendum flag 634 (not shown in FIG. 6). For example, as described in the ID Map discussion above, a fixed four-bit fixed pattern such as ‘1000’ (in this example, the leading ‘100’ indicating special features pattern followed by a ‘0’) may be used to indicate ID Values encoding plus an addendum flag. In an embodiment, this pattern may be followed by an addendum flag and a special features flag indicating the presence of an addendum and a special features section. If instead the data structure uses an ID Map (e.g., an IDMPO), then an addendum flag 634 may be encoded as described in the ID map discussion above.

In an embodiment, an addendum flag (e.g., addendum flag 634 or encoded in the preface of a IDVPO as described above) is not set until an addendum is encoded (e.g., addendum flag is set to a first value such as ‘0’ unless and until the Packed Object is edited, then it is set to a second value such as ‘1’). The addendum flag (e.g., addendum flag 634 or encoded in the preface of a IDVPO) is sufficient to make the Packed Object editable, with some restrictions as follows.

First, unless a null addendum section has been added (e.g., in anticipation for the need for future editing), the object is only editable until another object is written immediately following it in memory.

If the data structure uses a variable-length ID Values list instead of an ID Map (e.g., is an IDVPO instead of an IDMPO), then this list cannot change in size. The Addendum fields nonetheless provide an ability to add and delete data items, but the ID Values list itself cannot be changed (thus adding some complexity to the decoding system's task of determining presence/absence of data items based on the ID section alone). Note that this problem does not arise if an ID Map (e.g., in an IDMPO) is used instead of an ID Values list (e.g., in an IDVPO).

Unless redundant encoding of an Object Length field (e.g., object length 527) is employed (e.g., as described below), the future addendum length is limited by the remaining capacity of the encoded Object Length field.

In the following subsections of this text, various considerations and components of exemplary embodiments of the optional Addendum Section are described in detail.

Implications and Considerations Related to Various Addendum Section Embodiments

In an embodiment, if a Packed Object's Addendum Flag is set (e.g., to a first value such as ‘1’), then the pad indicator near the front of the Packed Object refers to the last byte preceding the addendum section, not the last byte of the Packed Object.

In an embodiment, if a Packed Object's Addendum Flag is set (e.g., to a first value such as ‘1’) in an IDMPO, then the decoding system may recognize that the ID Map does not necessarily reflect the number and order of data items that are encoded in the body of the Packed Object. The ID Map in this example is still useful for searching a population of tags, as it correctly reflects the end result of original encodings plus any additions and deletions. However, in order to decode the data from such a Packed Object, the decoding system must first process both the ID Map and the Addendum Section in order to determine which identifiers were encoded in the body and which were encoded in an Addendum Structure.

In an embodiment, if a Packed Object's Addendum Flag is set (e.g., to a first value such as ‘1’) in an IDVPO, then the above decoding consideration does not apply because the ID Values List reflects only those data items that were originally encoded in the body of the Packed Object. Instead, the decoding system may recognize that the ID Values list is no longer a true reflection of the net contents of the Packed Object, and that the contents may be determined by examining the Addendum Structures along with the original ID Values list.

Consideration: Editing Security

Various rules in exemplary embodiments of an Addendum mechanism may be used to help prevent or deter unauthorized modification of previously encoded and locked data items. For example, a Packed Object may not be edited after its creation, unless the entity originally encoding the Packed Object chose to make it editable by encoding an Addendum flag; and the entity attempting the edit has write-access to the start of the Object in order to modify the Object Length, to the bits past the end of the Object where the new Addendum may be place, and in many cases, to the end of the Object in order to overwrite the original Addendum Length with the start of the next Addendum Structure. Also, a new encoded appearance of an identifier (in a new object) may not be sufficient to “replace” the old appearance. Only the first new appearance (after the last explicit deletion) may be considered valid by an exemplary decoding system.

“Redundant Encoding” of the Object Length Field

In embodiments, redundant versions of Object Length field 527 may be considered valid and may be processed according to standard extensible bit vector (EBV) rules. To support future addition of an Addendum section, an encoder may choose to use a less-efficient encoding form for Object Length 527 in order to reserve room for growth of the object during later editing. For example, an embodiment of Object Length 527 is implemented as an EBV-6 field. The value “000011” is sufficient to indicate the number “3”. However, a six bit EBV-6 value imposes a 32 byte object length limit. Thus, a redundant version of Object Length 527 (such as “100000 100000 000011” to indicate the same number “3”) may be considered valid.

Preferred Use of ID Map Encoding if Editing is Anticipated

As described above, the leading ID sections of an IDVPO (i.e., not having an ID Map) may not properly indicate the list of encoded identifiers. Although decoding systems may properly process Add, Delete, and Replace operations, an exemplary decoding system may have to read an Addendum section over the air to determine the true ID list in an IDVPO. Therefore, an ID Map encoding (e.g., in an IDMPO) may be used if there is an expectation that editing features will be employed often.

Encoding a Null Addendum Section, if Future Editing is Anticipated

As described above, once another Packed Object is written following and adjacent to the current Packed Object, there may be no room to add an Addendum to the current Packed Object and future editing may be precluded. To reserve the capability for future editing, a null Addendum may be encoded at the end of the current Packed Object. A null Addendum large enough to encode a “deletions” list sufficient to mark as deleted all or a predetermined percentage of the data items currently encoded may be a reasonable compromise between encoding efficiency and future editability. Future additions may be handled by adding another Packed Object at the next free memory location at the time of addition. Future Replace operations may be handled by deleting the original value (e.g., using the null addendum) and adding the replacement data item to a new Packed Object.

### Methods

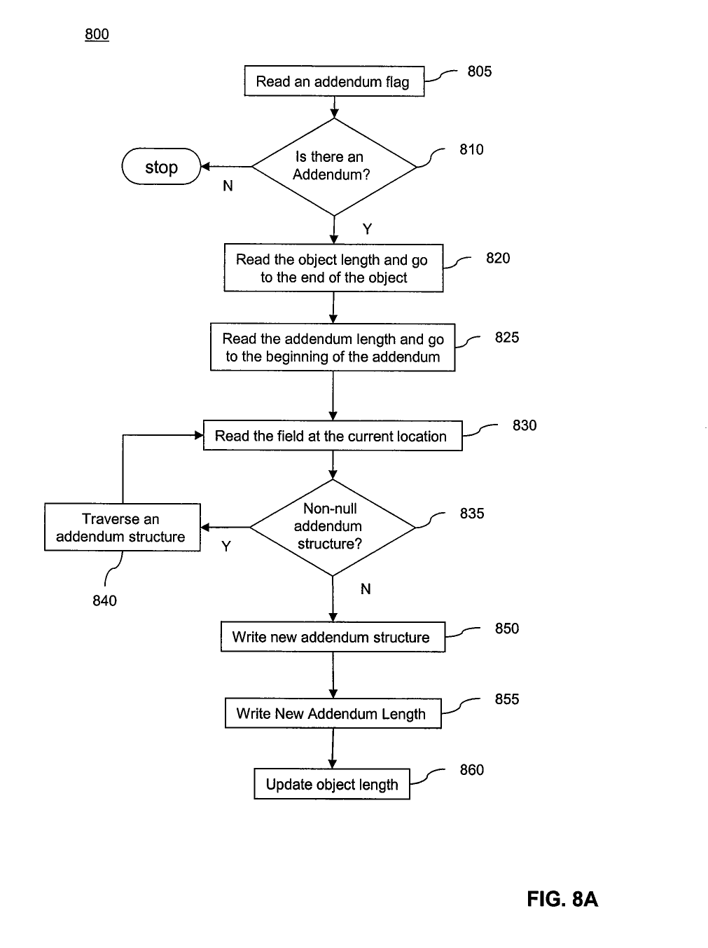

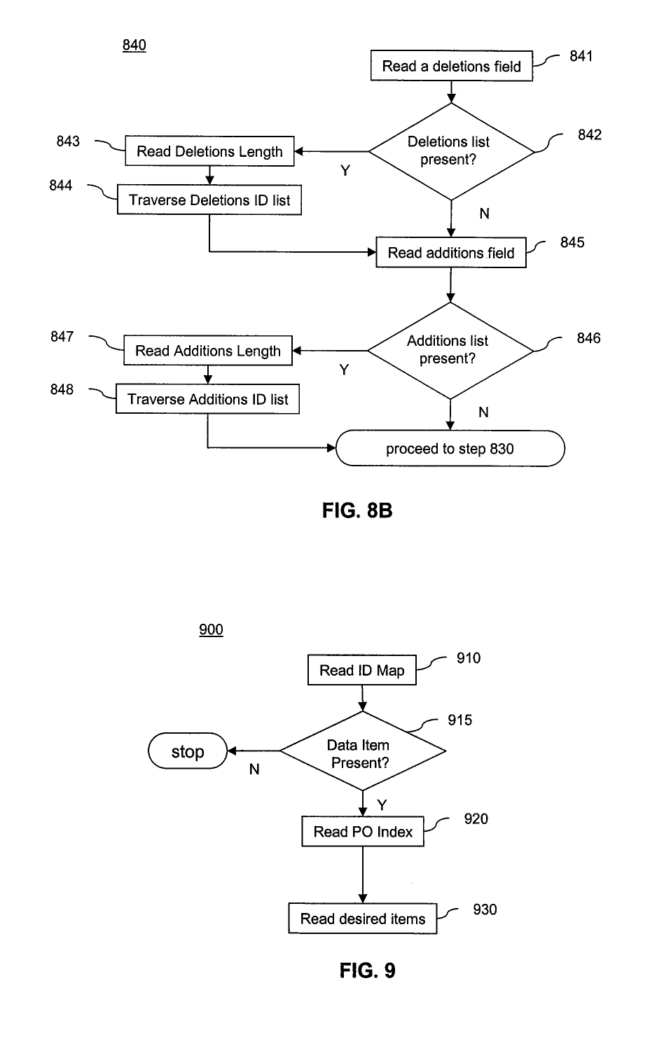

FIG. 8A depicts a flowchart 800 illustrating an exemplary method for editing a data structure (e.g. a Packed Object) according to embodiments of the present invention. Flowchart 800 is described in the context of a Packed Object, however, the method described by flowchart 800 is not limited to those embodiments. Not all of the steps in flowchart 800 must occur in the order shown and some steps are optional. Not all techniques that could be used to edit a data structure are described in flowchart 800.

In step 805, an addendum flag is read. In an embodiment, an addendum flag as described elsewhere herein (e.g., addendum flag 634 or an addendum flag encoded in the preface to a Packed Object) indicates whether there is an addendum encoded.

In step 810, a determination of whether an Addendum is present is made. If the addendum flag read in step 805 indicates there is no addendum, the data structure is not editable by this process. If the addendum flag indicates that there is an addendum, proceed to step 820.

In step 820, the object length is read and the object is traversed to the end. In an embodiment, an object length is encoded into the data structure indicating the length of the data structure as described elsewhere herein (e.g., for a Packed Object, object length 527). This object length informs a reader where the end of the current data structure is.

In step 825, the addendum length is read, and the addendum is traversed to the beginning of the addendum. In an embodiment, the data structure has an addendum at the end with a trailing addendum length field as described elsewhere herein (e.g. addendum length 678). The addendum length indicates where the beginning of the addendum is located relative to the end of the addendum.

In step 830, the field at the current location is read.

In step 835, a determination whether the current field indicates a non-null addendum is made. The field read in step 830 may indicate that the there is a null addendum field encoded at that location and thus the proper location for a new addendum structure has been found, and control proceeds to step 850. The field read may indicate that there is an existing non-null addendum structure at that location. In that case, the addendum structure must be traversed, and control proceeds to step 840. The field read in step 830 may indicate that there is no addendum structure at that location (null or otherwise), and thus the proper location for a new addendum structure has been found, and control proceeds to step 850.

In step 840, the addendum structure is traversed. In an embodiment, the addendum structure is traversed. Step 840 is described in further detail in FIG. 8B.

In step 850, a new addendum structure is written. In this step, the edit (e.g., deletion or addition) is made by appending a new addendum structure to the data structure. The new addendum structure is as described elsewhere herein (e.g., addendum structure 660).

In step 855, a new addendum length is written. In this step, a new addendum length is appended to the data structure to represent the new length including the addendum structure written in step 850.

In step 860, the object length is updated. In this step, the object length field read in step 820 is updated to reflect the new data structure length.

FIG. 8B depicts a flowchart 840 of an exemplary method for traversing an addendum structure according to embodiments of the present invention. Flowchart 840 is described in the context of a Packed Object, however, flowchart 840 is not limited to those embodiments. Note that not all of the steps in flowchart 840 must occur in the order shown and some steps are optional. Not all techniques that could be used to traverse an addendum structure are described in flowchart 840.

In step 841, a deletions field is read. In an embodiment, the deletions field is as described above (e.g., deletions bit 662).

In step 842, a determination whether there is a deletions list in the current addendum structure is made. In an embodiment, the deletions field read in step 841 indicates whether there is a deletions list in the current addendum structure. If there is a deletions list, control proceeds to step 843. If there is not, control proceeds to step 845.

In step 843, a deletions length field is read. In an embodiment, a deletions length field as described elsewhere herein (e.g., deletions length 664) indicating the length of the deletions ID list is read.

In step 844, a deletions ID list is traversed. In an embodiment, a deletions ID list as described elsewhere herein (e.g., deletions ID list 666) is traversed. In an embodiment, the deletions length read in step 843 indicates the length of the ID list.

In step 845, an additions field is read. In an embodiment, the additions field is as described elsewhere herein (e.g., a deletions bit 662).

In step 846, a determination of whether there is an additions list in the current addendum structure is made. In an embodiment, the additions field read in step 843 indicates whether there is an additions list in the current addendum structure. If there is an additions list, control proceeds to step 847. If there is not, control proceeds out of this flowchart to step 830 in Flowchart 800 illustrated in FIG. 8A.

In step 847, an additions length is read. In an embodiment, an additions length field as described elsewhere herein (e.g., additions length 674) indicates the length of the additions ID list.

In step 848, an additions ID list is traversed. In an embodiment, an additions ID list is as described elsewhere herein (e.g., additions ID list 676). In a further embodiment, one or more of ID bits, Aux ID, and data sections fields must also be traversed in this step. In an embodiment, the deletions length read in step 843 indicates the length of the ID list (and any other fields).

FIG. 9 depicts a flowchart 900 of an exemplary method for reading one or more data items according to embodiments of the present invention. Flowchart 900 is described in the context of a Packed Object, however, flowchart 900 is not limited to those embodiments. Note that not all of the steps in flowchart 900 must occur in the order shown, and some steps are optional. Not all techniques that could be used to read data items are described in flowchart 900.

In step 910, an ID Map is read. In an embodiment, an ID map is as described above (e.g., a portion of or a complete ID Map Structure 602).

In step 915, a determination is made if the desired data item is present on the tag. In an embodiment, this determination is made based on the ID Map read in step 910. If the data item is available, control proceeds to step 920. If not, the item is not present and cannot be read.

In step 920, a PO Index is read. In an embodiment, the PO index is as described elsewhere herein (e.g., PO index 640), and indicates which of the data objects on the tag contain the desired item.

In step 930, a desired data items is read.

### Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner. Likewise, particular bit values of “0” or “1” (and representative voltage values) are used in illustrative examples provided herein to represent data for purposes of illustration only. Data described herein can be represented by either bit value (and by alternative voltage values), and embodiments described herein can be configured to operate on either bit value (and any representative voltage value), as would be understood by persons skilled in the relevant art(s).

What is claimed is:

1. A data structure embodied in a tangible computer readable medium comprising:
at least one data section encoding at least one data item; and
an identification map having a plurality of item present fields, each item present field corresponding to an entry in an external table, wherein a first item present field value indicates the presence of a data item for the entry in the at least one data section substructure.

2. A system of structures embodied in a tangible computer readable medium comprising:
at least one data structure, each data structure encoding at least one data item; and
a directory structure comprising an identification map having a plurality of item present fields, each item present field corresponding to an entry in an external table, wherein a first item present field value indicates the presence of a data item for the entry in the system of structures.

3. The system of claim 2, wherein the directory structure further comprises an auxiliary map having a plurality of data location fields.

4. The system of claim 3, wherein a data location field of the auxiliary map has a value indicating the position of a data structure containing an encoded data item.

5. A system of structures embodied in a tangible computer readable medium comprising:
a means for storing a plurality of encoded data items, each data item having characteristics defined by an external table; and
a means for storing a plurality of encoded identification entries, each encoded identification entry indicating the presence of encoded data corresponding to a corresponding entry in the external table,
wherein the location of each encoded identification entry is fixed in the tangible computer readable medium regardless of the encoded length of each encoded data item.

6. A system of structures embodied in a tangible computer readable medium comprising:
a data structure means for storing a plurality of encoded data items;
an addendum means for modifying a previously stored encoded data item in the data structure means without modifying the data structure means; and
an addendum indicator means for associating the data structure means with the addendum means.

7. The system of claim 7, wherein the addendum indicator means comprises a means for indicating the previously stored encoded data item cannot be modified using the addendum means.

8. A system of structures embodied in a tangible computer readable medium comprising:
a packed object including a means for storing a previously encoded data item;
a deletion list including a means for indicating the previously encoded data item is deleted.

9. A system of structures embodied in a tangible computer readable medium comprising:
a packed object comprising a previously encoded data item; and
a deletion list comprising a deleted identifier associated with the previously encoded data item.

10. A system of structures embodied in a tangible computer readable medium comprising:
a packed object including a means for storing a previously encoded data item;
an addition list including a means for indicating the previously encoded data item is superseded.

11. A system of structures embodied in a tangible computer readable medium comprising:
a packed object comprising a previously encoded data item; and
an addition list comprising an added identifier.

12. The system of claim 11, wherein the added identifier is associated with the previously encoded data item and a value associated with the added identifier supersedes the value of the previously encoded data item.

13. A radio frequency identification (RFID) tag, comprising:
an antenna;
control logic; and
a memory including a system of structures embodied thereon, the system comprising:
a data section encoding at least one data item; and
an identification map having a plurality of item present fields, each item present field corresponding to an entry in an external table, wherein a first item present field value indicates the presence of a data item for the entry in the memory.

14. The RFID tag of claim 13, wherein the memory further comprises a packed object comprising the data section.

15. A radio frequency identification (RFID) tag, comprising:
an antenna;
control logic; and
a memory including a data structure embodied thereon, the data structure comprising:
a data section including a previously encoded data item;
a deletion list including a deleted identifier associated with the previously encoded data item; and
an addition list including an added identifier.

16. A method for selecting a radio frequency identification (RFID) tag, comprising:
(a) sending a command to select a subset of a population of tags containing data items of interest, where the subset is defined by matching a bit pattern in an identification map stored on the tag;
(b) sending a command for a matching tag to respond; and
(c) receiving a reply from an RFID tag selected in step (a).

17. A method for accessing data stored within a data structure embodied in a tangible computer readable medium, comprising:
(a) performing a first read of a tag to retrieve an identification map indicating the presence of a set of data items in the tag;
(b) determining whether a data item of interest is stored on the tag using the identification map; and
(c) performing a second read of the tag to retrieve a data structure containing the data item of interest.

18. A method for accessing data stored within a data structure embodied in a tangible computer readable medium, comprising:
(a) performing a first read of a tag to retrieve an identification map indicating the presence of a set of data items in the tag;
(b) determining whether a data item of interest is stored on the tag using the identification map;
(c) performing a second read of the tag to retrieve a data structure index table to determine the location of the data structure containing the data item of interest; and
(d) performing a third read to retrieve the data item of interest using the retrieved location information.
